(19) United States
(12) Patent Application Publication
(10) Pub. No.: US 2026/0348558 A1
(43) Pub. Date: Nov. 5, 2026

(54) LIGHT FIXTURE INCLUDING A THREE-BAR FRAME SOLVER FOR SHUTTER CONTROL

(71) Applicant: Electronic Theatre Controls, Inc., Middleton, WI (US)

(72) Inventor: Noah Meltzer, Middleton, WI (US)

(21) Appl. No.: 19/739,262

(22) Filed: Jul. 13, 2026

Related U.S. Application Data
(63) Continuation-in-part of application No. 19/092,708, filed on Mar. 27, 2025.

(51) Int. Cl. F21V 11/10; F21Y 115/10; G02B 7/00

(52) U.S. Cl. CPC F21V 11/10; G02B 7/005; F21Y 2115/10

(57) ABSTRACT

A light fixture including a housing, a light source, a framing shutter system, and an electronic processor. The electronic processor is connected to the light source and the framing shutter system. The electronic processor is configured to determine a desired orientation of a framing shutter blade, determine whether the desired orientation is within a set of physically possible positions of the framing shutter blade, determine an adjusted orientation of the framing shutter blade, wherein the adjusted orientation is based on the desired orientation, the adjusted orientation of the framing shutter blade corresponding to an orientation for the framing shutter blade that is included in the set of physically possible positions, and control the plurality of framing shutter motors to move the framing shutter blade to the adjusted orientation.

### CROSS-REFERENCE TO RELATED APPLICATIONS

This application is a continuation-in-part of U.S. patent application Ser. No. 19/092,708, filed Mar. 27, 2025, the entire contents of which are hereby incorporated by reference herein.

### FIELD

Embodiments described herein provide light fixtures and methods for controlling the light fixtures.

### SUMMARY

Embodiments described herein relate to techniques for controlling three-bar frame systems that are more effective than existing techniques. Existing techniques for controlling three-bar frame systems often use what is referred to as “A/B” control. Using an A/B control scheme, a user or a light fixture sets an angle of a first arm and an angle of a second arm individually in order to move a framing shutter blade to a desired orientation. The A/B control scheme is a less intuitive way to set the desired orientation of the framing shutter blade. In contrast to the A/B control scheme, embodiments described herein utilize a control scheme where an angle value of the framing shutter blade and a thrust value of the framing shutter blade are used to control the orientation of the framing shutter blade. The thrust-angle control scheme provides a more intuitive control of the framing shutter blade. Further, by utilizing the thrust-angle control scheme, either the inverse kinematics or the forward kinematics of the framing shutter blade can be used (e.g., in a cost function) to optimize control of the framing shutter blade in the event that a desired thrust-angle is outside the gamut of the framing shutter blade.

Embodiments described herein relate to a light fixture including a housing, a light source, and a framing shutter system. The framing shutter system includes a framing shutter gate, a framing shutter blade, and a plurality of framing shutter motors connected to the framing shutter blade. The light fixture also includes an electronic processor electrically connected to the light source and the framing shutter system. The electronic processor is configured to determine a desired orientation of the framing shutter blade defined by a desired first value and a desired second value, determine whether the desired orientation is within a set of physically possible positions of the framing shutter blade, determine, in response to the desired orientation being outside of the set of physically possible positions of the framing shutter blade, an adjusted orientation of the framing shutter blade defined by an adjusted first value and an adjusted second value, wherein the adjusted second value is determined based on the adjusted first value, and wherein at least one of the adjusted first value and the adjusted second value is determined based on the desired first value and the desired second value, the adjusted orientation of the framing shutter blade corresponding to an orientation for the framing shutter blade that is included in the set of physically possible positions, and control the plurality of framing shutter motors to move the framing shutter blade to the adjusted orientation.

In some embodiments, the adjusted first value and the adjusted second value are determined based on a weight that prioritizes one of the desired first value and the desired second value relative to the other of the desired first value and the desired second value.

In some embodiments, the desired first value is an angle value of the framing shutter blade and the desired second value is a thrust value of the framing shutter blade.

In some embodiments, the angle value defines a rotational orientation of the framing shutter blade relative to a virtual pivot circle.

In some embodiments, the thrust value is used to determine a parameter that defines a size or position of the virtual pivot circle.

In some embodiments, the parameter is a radius of the virtual pivot circle.

In some embodiments, the framing shutter blade is tangent to the virtual pivot circle.

In some embodiments, the virtual pivot circle defines a path along which the framing shutter blade moves.

In some embodiments, the desired first value is a thrust value of the framing shutter blade and the desired second value is an angle value of the framing shutter blade.

In some embodiments, the thrust value defines a location of a virtual pivot point and the angle value defines a rotation of the framing shutter blade about the virtual pivot point.

Other embodiments described herein relate to a method for controlling a light fixture. The method includes determining, using an electronic processor, a desired orientation of a framing shutter blade defined by a desired first value and a desired second value; determining, using the electronic processor, whether the desired orientation is within a set of physically possible positions of the framing shutter blade; determining, using the electronic processor and in response to the desired orientation being outside of the set of physically possible positions of the framing shutter blade, an adjusted orientation of the framing shutter blade defined by an adjusted first value and an adjusted second value, wherein the adjusted second value is determined based on the adjusted first value, and wherein at least one of the adjusted first value and the adjusted second value is determined based on the desired first value and the desired second value, the adjusted orientation of the framing shutter blade corresponding to an orientation for the framing shutter blade that is included in the set of physically possible positions; and controlling, using the electronic processor, a plurality of framing shutter motors to move the framing shutter blade to the adjusted orientation.

In some embodiments, determining the adjusted orientation further includes determining the adjusted first value and the adjusted second value based on a weight that defines a relative priority between the desired first value and the desired second value.

In some embodiments, determining the desired orientation further includes determining an angle value and a thrust value of the framing shutter blade, wherein the desired first value is the angle value and the desired second value is the thrust value.

In some embodiments, determining the angle value further includes determining a rotational orientation of the framing shutter blade relative to a virtual pivot circle.

In some embodiments, determining the thrust value further includes determining a parameter that defines a size or position of the virtual pivot circle.

In some aspects, the method further includes determining a radius of the virtual pivot circle based on the thrust value.

In some embodiments, the framing shutter blade is tangent to the virtual pivot circle.

In some embodiments, determining the desired orientation further includes determining a thrust value and an angle value of the framing shutter blade, wherein the desired first value is the thrust value and the desired second value is the angle value.

In some embodiments, determining the thrust value further includes determining a location of a virtual pivot point and determining the angle value further includes determining a rotation of the framing shutter blade about the virtual pivot point.

Further embodiments described herein relate to a light fixture including a housing, a light source, and a framing shutter blade system. The framing shutter blade system includes a first arm, a second arm, a framing shutter blade including a first blade slot configured to receive the first arm in a slidable manner and a second blade slot configured to receive the second arm in a slidable manner, a first framing shutter motor including a first output shaft, the first framing shutter motor being connected to the first arm via the first output shaft, and a second framing shutter motor including a second output shaft, the second framing shutter motor being connected to the second arm via the second output shaft. The light fixture also includes an electronic processor electrically connected to the light source and the framing shutter blade system. The electronic processor is configured to receive a desired angle of the framing shutter blade, receive a desired thrust of the framing shutter blade, determine a desired orientation based on the desired angle and the desired thrust, determine an adjusted orientation of the framing shutter blade defined by an adjusted angle and an adjusted thrust, wherein at least one of the adjusted angle and the adjusted thrust is determined based on the desired angle and the desired thrust, determine that the adjusted orientation is within a set of physically possible positions of the framing shutter blade, and adjust the first arm and the second arm, in response to determining the adjusted orientation is within the set of physically possible positions, by controlling the first framing shutter motor and the second framing shutter motor to move the framing shutter blade to the adjusted orientation, wherein the desired angle defines a rotational orientation of the framing shutter blade relative to a virtual pivot circle, and wherein the desired thrust corresponds to a parameter that defines a size or position of the virtual pivot circle.

Before any embodiments are explained in detail, it is to be understood that the embodiments are not limited in application to the details of the configurations and arrangements of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to perform any one or more of the recited multiple functions, such that the one or more elements, as a set, perform the multiple functions collectively.

Other aspects of the embodiments will become apparent by consideration of the detailed description and accompanying drawings.

### BRIEF DESCRIPTION OF THE DRAWINGS

FIG. 1 illustrates a light fixture, according to embodiments described herein.

FIG. 2 illustrates the light fixture of FIG. 1 with a portion of a housing removed, according to embodiments described herein.

FIG. 3 illustrates a control system for the light fixture of FIG. 1, according to embodiments described herein.

FIG. 4A illustrates a framing shutter system, according to embodiments described herein.

FIG. 4B illustrates a framing shutter system, according to embodiments described herein.

FIG. 4C illustrates a framing shutter gate, according to embodiments described herein.

FIG. 5 illustrates a framing shutter blade system, according to embodiments described herein.

FIG. 6A illustrates a framing shutter blade system, according to embodiments described herein.

FIG. 6B illustrates a framing shutter blade system, according to embodiments described herein.

FIG. 6C illustrates a virtual pivot circle of FIG. 6B, according to embodiments described herein.

FIG. 7A illustrates a framing shutter blade system, according to embodiments described herein.

FIG. 7B illustrates a framing shutter blade system, according to embodiments described herein.

FIG. 8 illustrates a graph of a cost surface with a solver path, according to embodiments described herein.

FIG. 9 illustrates a gamut chart of a framing shutter blade, according to embodiments described herein.

FIG. 10 illustrates a process for controlling the light fixture of FIG. 1, according to embodiments described herein.

FIG. 11A illustrates a graph of a target thrust and angle and an achieved thrust and angle according to a thrust-angle weight, according to embodiments described herein.

FIG. 11B illustrates a graph of a target thrust and angle and an achieved thrust and angle according to a thrust-angle weight, according to embodiments described herein.

FIG. 11C illustrates a graph of a target thrust and angle and an achieved thrust and angle according to a thrust-angle weight, according to embodiments described herein.

### DETAILED DESCRIPTION

Light fixtures described herein include a housing, a light source, a framing shutter system, and an electronic processor. The framing shutter system includes a framing shutter gate, a framing shutter blade, and a plurality of framing shutter motors connected to the framing shutter blade. The electronic processor is electrically connected to the light source and the framing shutter system and is configured to determine a desired orientation (e.g., a desired thrust and a desired angle) of the framing shutter blade and determine whether the desired orientation is within a gamut (e.g., a set of all physically possible positions) of the framing shutter blade. If the desired orientation is outside of the gamut of the framing shutter blade, an adjusted orientation of the framing shutter blade is determined. The adjusted orientation of the framing shutter blade corresponds to an orientation for the framing shutter blade that is as close as possible (e.g., as defined by a cost function and an angle-thrust weight) to the desired orientation. The plurality of framing shutter motors can then be controlled to move the framing shutter blade to the adjusted orientation.

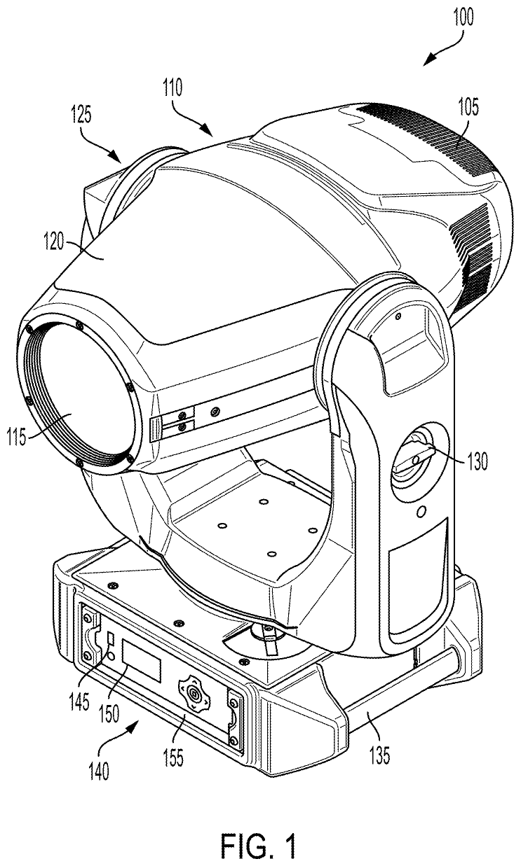

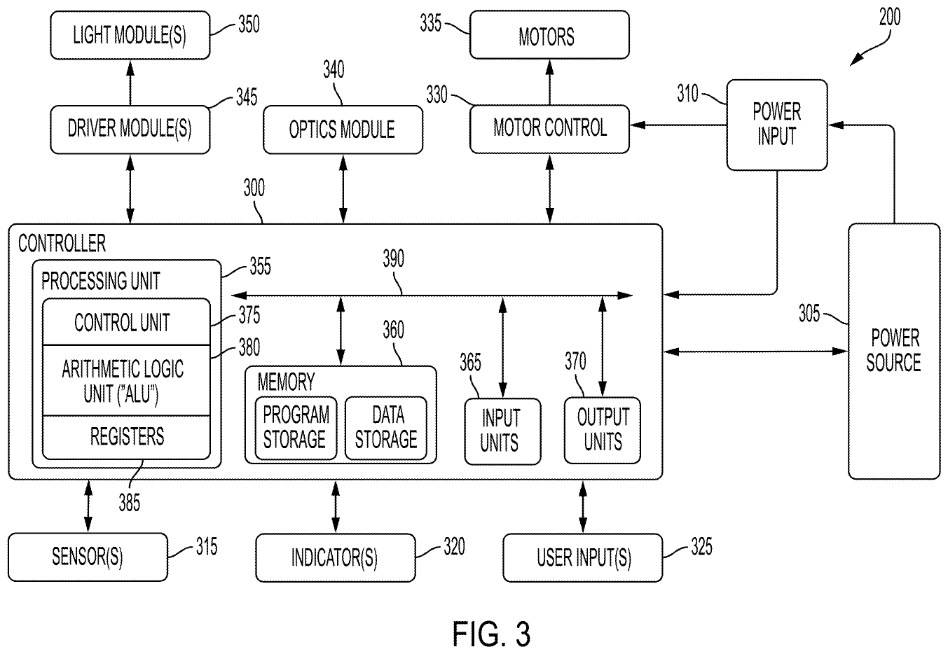

FIG. 1 illustrates a light fixture 100. Light fixture 100 includes a light module rear cover 105. In some embodiments, the light module rear cover 105 contains a light module 350 (see FIG. 3) that includes a light source, a driver board, a reflector, and a fan assembly. The light source is, for example, an array of light emitting diodes (“LEDs”). Light fixture 100 also includes a housing 110 and a front lens 115. In some embodiments, the front lens 115 is configured to guide light from the light source contained by the light module rear cover 105. The light fixture 100 also includes a head 120. As a component of the housing 110, the head 120 is configured to contain an optics module 340 (see FIG. 3). Additionally, the light fixture 100 includes a yoke arm cover 125 configured to contain a yoke assembly configured to change an angle of tilt of the head 120 of the light fixture 100. In some embodiments, the yoke assembly contained by yoke arm cover 125 is configured to allow the light fixture 100 to be mounted on an external surface. The yoke arm cover 125 further includes a tilt lock 130 configured to lock the light fixture at a specific angle of tilt. Light fixture 100 includes a handle 135 configured to allow the light fixture 100 to be carried or attached to an external surface. Light fixture 100 also includes a control module 140 configured as a user interface for controlling, for example, various settings of the light fixture 100. The control module 140 further includes a USB port 145, a display 150, and navigation buttons 155.

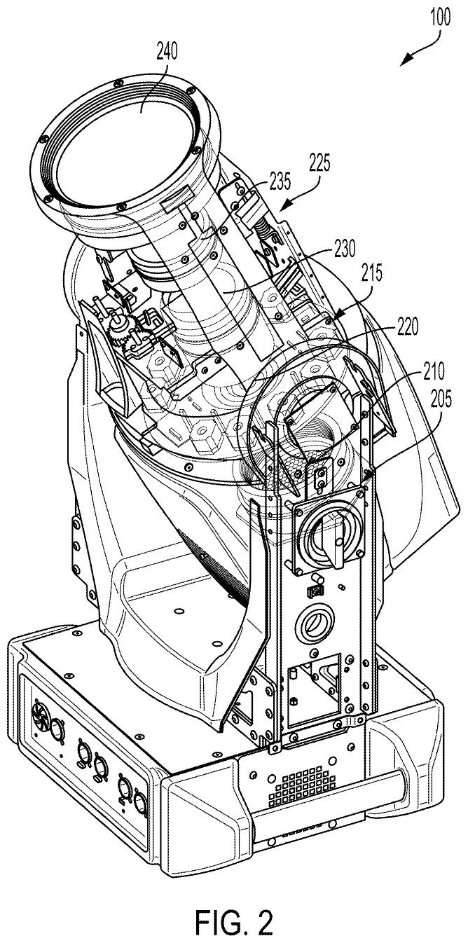

FIG. 2 illustrates the light fixture 100 with a portion of the housing 110 removed to expose internal components of the light fixture 100. The light fixture 100 includes a light module 205 including a light source 210. As previously described, the light source 210 can be an array of LEDs. The light fixture 100 also includes a framing shutter system 215 configured to control the shape of a gate 220. The gate 220 is included in the framing shutter system 215. The light fixture 100 further includes an optics module 225. The optics module 225 includes a focus lens 230 and zoom lens 235. Light fixture 100 further includes a front lens 240.

FIG. 3 illustrates a control system for controlling the light fixture 100. The control system includes a controller 300. The controller 300 is electrically and/or communicatively connected to a variety of modules or components of the light fixture 100. For example, the controller 300 is connected to a power source 305, power input module 310, one or more sensors or sensing circuits 315, one or more indicators 320, a user input module 325, a motor control module 330, a plurality of framing shutter motors 335, an optics module 340, one or more driver modules 345, and one or more light modules 350. The controller 300 includes combinations of hardware and software that are operable to, among other things, control the operation of the light fixture 100, monitor a condition of the light fixture 100, control operation of the framing shutter system 215, etc.

The controller 300 includes a plurality of electrical and electronic components that provide power, operational control, and protection to the components and modules within the controller 300 and/or the light fixture 100. For example, the controller 300 includes, among other things, a processing unit 355 (e.g., a microprocessor, a microcontroller, an electronic controller, an electronic processor, or another suitable programmable device), a memory 360, input units 365, and output units 370. The processing unit 355 includes, among other things, a control unit 375, an arithmetic logic unit (“ALU”) 380, and a plurality of registers 385 (shown as a group of registers in FIG. 3) and is implemented using a known computer architecture (e.g., a modified Harvard architecture, a von Neumann architecture, etc.). The processing unit 355, the memory 360, the input units 365, and the output units 370, as well as the various modules or circuits connected to the controller 300 are connected by one or more control and/or data buses (e.g., common bus 390). The control and/or data buses are shown generally in FIG. 3 for illustrative purposes. The use of one or more control and/or data buses for the interconnection between and communication among the various modules, circuits, and components would be known to a person skilled in the art in view of the disclosure provided herein.

The memory 360 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 355 is connected to the memory 360 and executes software instructions that are capable of being stored in a RAM of the memory 360 (e.g., during execution), a ROM of the memory 360 (e.g., on a generally permanent basis), or another non-transitory computer readable medium such as another memory or a disc. Software included in the implementation of the light fixture 200 can be stored in the memory 360 of the controller 300. The software includes, for example, firmware, one or more applications, program data, filters, rules, one or more program modules, and other executable instructions. The controller 300 is configured to retrieve from the memory 360 and execute, among other things, instructions related to the control processes and methods described herein. In other constructions, the controller 300 includes additional, fewer, or different components.

Power provided by power source 305 to the light fixture 100 is provided through the power input module 310. The power input module 310 includes combinations of active and passive components to regulate or control the power received from the power source 305 prior to power being provided to the controller 300.

The indicators 320 include, for example, one or more light-emitting diodes (“LEDs”). The indicators 320 can be configured to display conditions of, or information associated with, the light fixture 100. For example, the indicators 320 are configured to indicate measured characteristics of the light fixture 100 (e.g., pan angle, tilt angle, etc.), the status of the light fixture 100, etc. The user input module 325 is operably coupled to the controller 300 to, for example, turn on the light fixture 100. In some embodiments, the user input module 325 includes a combination of digital and analog input or output devices required to achieve a desired level of operation for the light fixture 100, such as one or more knobs, one or more dials, one or more switches, one or more buttons, etc. In some embodiments, the user input module 325 includes the control module 140 of FIG. 1.

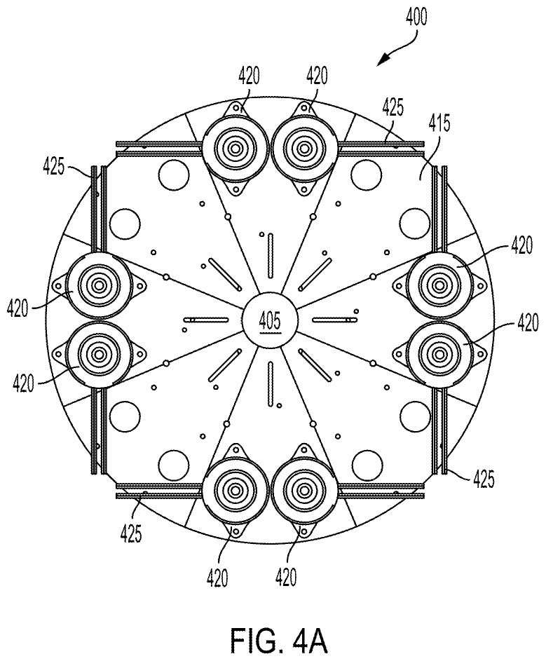

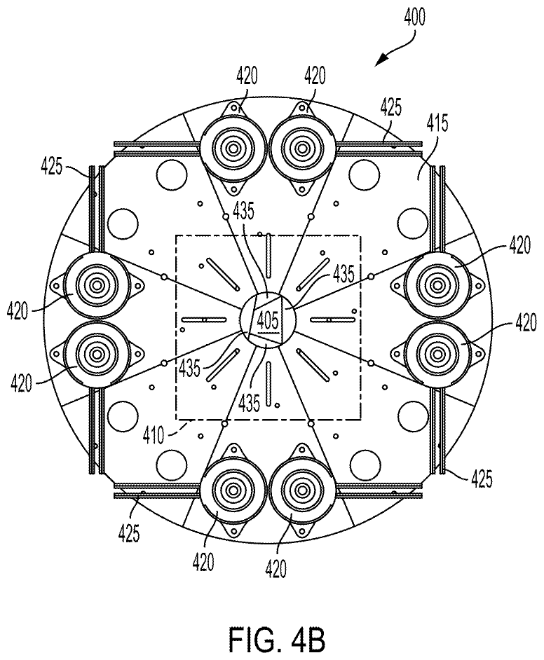

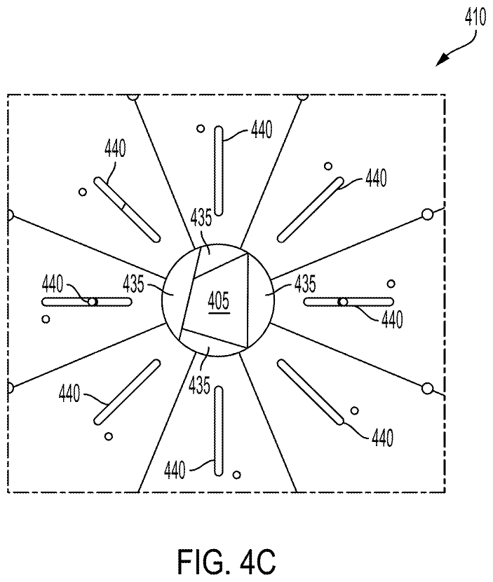

FIG. 4A illustrates a framing shutter system 400 including an open framing shutter gate 405. Regarding FIGS. 4A and 4B, the framing shutter system 400 includes a wheel 415 and a plurality of framing shutter motors 420. The plurality of framing shutter motors 420 are configured to be at least partially fixed to the wheel 415 and are used to control the position of four framing shutter blades. Additionally, the plurality of framing shutter motors 420 are at least partially fixed to a support portion 425 in order to provide additional structural support to the framing shutter system 400.

FIG. 4B illustrates the framing shutter system 400 including a partially closed framing shutter gate 405. The partially closed framing shutter gate 405 is partially closed due to framing shutter blades 435. The plurality of framing shutter motors 420 is connected to the framing shutter blades 435. An orientation of the framing shutter blades 435 is controlled by a controller (e.g., controller 300) using the plurality of framing shutter motors 420. Changing the orientation of the framing shutter blades 435 allows light to pass through the framing shutter gate 405 in various manners, which means that various shapes can be created with the light passing through the framing shutter gate 405. In some embodiments, the framing shutter system 400 includes four framing shutter blades 435, each operated by two of the plurality of framing shutter motors 420. In some embodiments, the framing shutter blades 435 have two degrees of freedom (e.g., thrust and angle).

FIG. 4C illustrates a detailed view of the partially closed framing shutter gate 405 including the framing shutter blades 435 and a plurality of indicators 440. The plurality of indicators represent the eight degrees of freedom for controlling the illustrated four framing shutter blades 435. In some embodiments, the framing shutter blades 435 include fewer than four framing shutter blades and therefore fewer than eight degrees of freedom. In some embodiments, the framing shutter blades 435 include more than four framing shutter blades and therefore more than eight degrees of freedom.

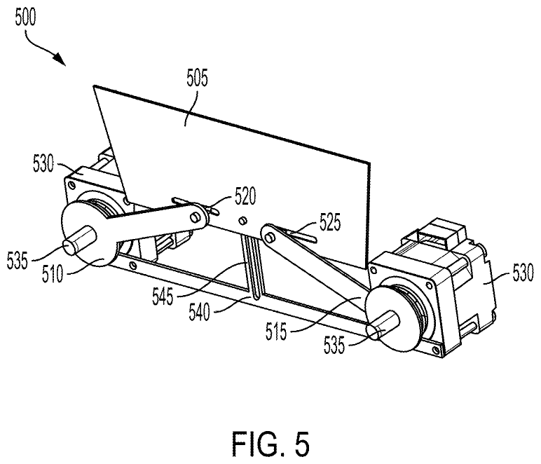

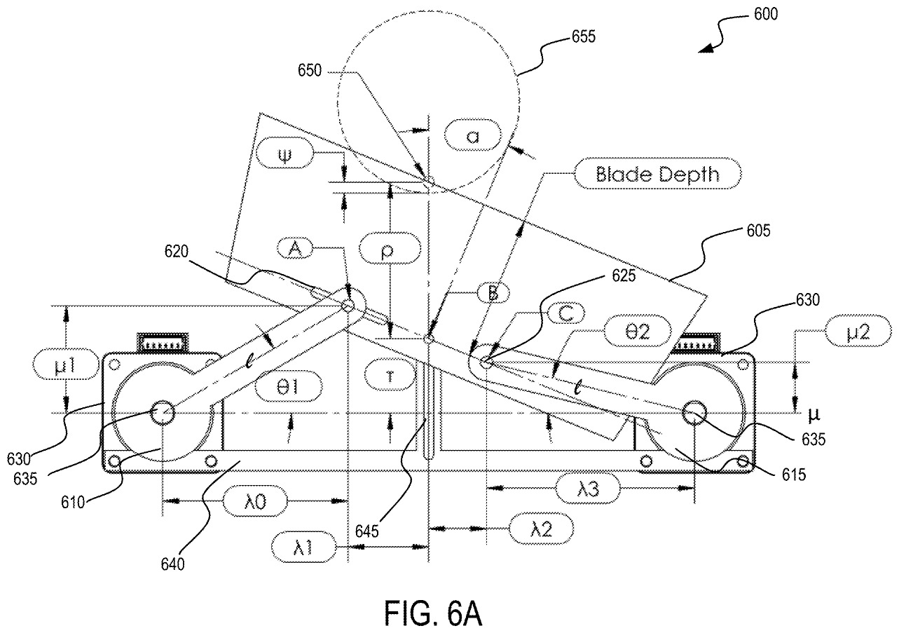

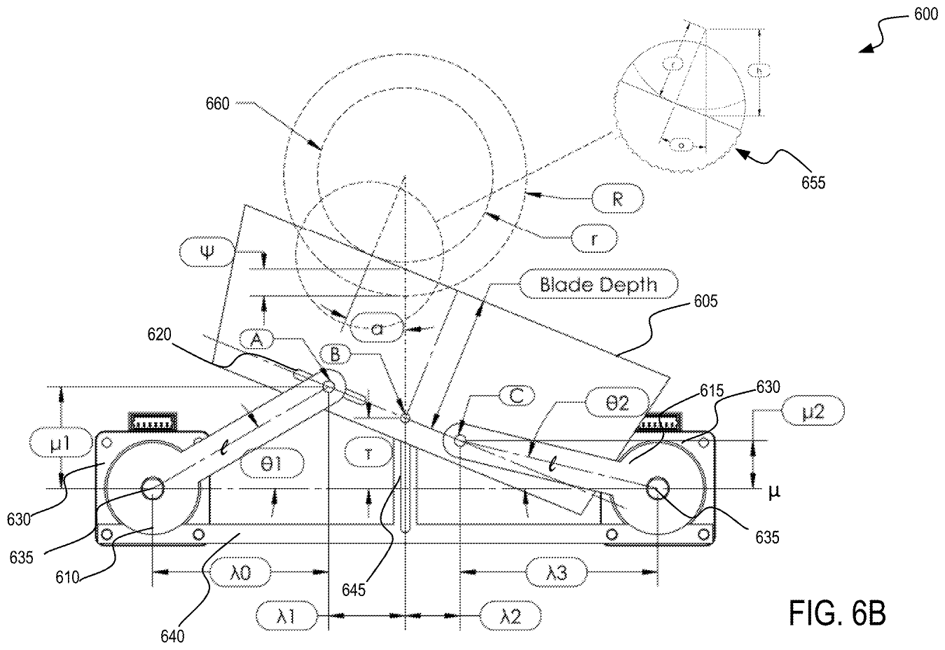

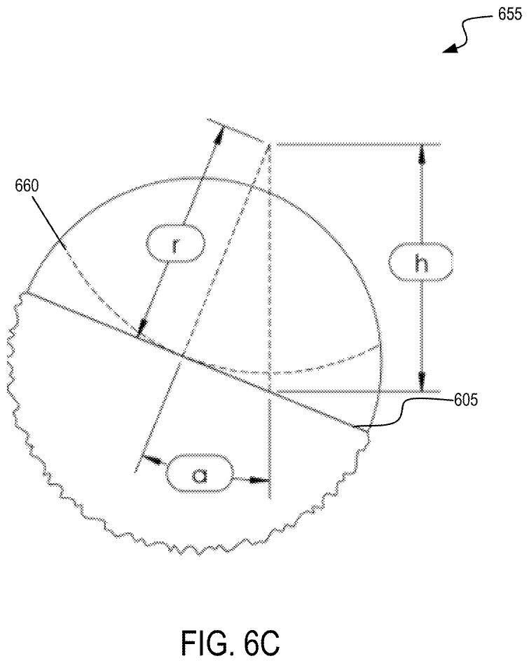

FIG. 5 illustrates a framing shutter blade system 500. The framing shutter blade system 500 includes a framing shutter blade 505, a first arm 510, a second arm 515, a first blade slot 520, a second blade slot 525, a plurality of framing shutter motors 530, and a support portion 540. The light fixture 100 would include, for example, four of the framing shutter blade systems 500 that can be individually controlled to achieve a desired shape for a gate (e.g., gate 405). The framing shutter blade 505 includes the first blade slot 520 and second blade slot 525. The first blade slot 520 and second blade slot 525 are configured to receive the first arm 510 and the second arm 515, respectively, in a slidable manner. The first arm 510 and second arm 515 each connect to one of the plurality of framing shutter motors 530 through an output shaft 535 of each of the plurality of framing shutter motors 530. In some embodiments, the first arm 510 and the second arm 515 are each one of the three bars in the three-bar frame. Each of the plurality of framing shutter motors 530 is at least partially fixed to the support portion 540. The support portion 540 further includes a track 545 configured to receive the framing shutter blade 505 in a slidable manner. In some embodiments, the track 545 is one of the three bars in the three-bar frame. As the plurality of framing shutter motors 530 are driven, the output shaft 535 of each of the plurality of framing shutter motors 530 rotates and causes the first arm 510 and the second arm 515 to rotate or pivot. The rotation of the first arm 510 and the second arm 515 may cause the relative positions of the first arm 510 and the second arm 515 within the first blade slot 520 and the second blade slot 525 respectively to be changed. As a result, an angle of the framing shutter blade 505 may change. The angle of the framing shutter blade is described in greater detail with respect to FIGS. 6A-6B. Additionally, the rotation of the first arm 510 and the second arm 515 may cause the framing shutter blade 505 to slide up or down the track 545 of the support portion 540. Changing the relative position of the framing shutter blade 505 along the track 545 may change a thrust of the framing shutter blade 505. The thrust of the framing shutter blade is described in greater detail with respect to FIGS. 6A-6B. The framing shutter blade system 500 is illustrated as an example shutter blade system. Other shutter blade systems that include different mechanical configurations can also be used in conjunction with forward and reverse kinematics and the cost function (described below) to control the operation of the particular shutter blade system.

FIG. 6A illustrates a framing shutter blade system 600 in greater detail. The framing shutter blade system 600 includes a framing shutter blade 605, a first arm 610, a second arm 615, a first blade slot 620, a second blade slot 625, a plurality of framing shutter motors 630, and a support portion 640. The framing shutter blade 605 includes the first blade slot 620 and second blade slot 625. The first blade slot 620 and second blade slot 625 are configured to receive the first arm 610 and the second arm 615 in a slidable manner. The first arm 610 and second arm 615 each connect to one of the plurality of framing shutter motors 630 through an output shaft 635 of each of the plurality of framing shutter motors 630. Each of the plurality of framing shutter motors 630 is at least partially fixed to the support portion 640. The support portion 640 further includes a track 645 configured to receive the framing shutter blade 605 in a slidable manner. As the plurality of framing shutter motors 630 are driven, the output shaft 635 of each of the plurality of framing shutter motors 630 rotates and causes the first arm 610 and the second arm 615 to rotate. The rotation of the first arm 610 and the second arm 615 may cause the relative positions of the first arm 610 and the second arm 615 within the first blade slot 620 and the second blade slot 625 to respectively change.

As a result, an angle value α of the framing shutter blade 605 relative to a virtual pivot point 650 may change. The angle value α of the blade describes the rotation of the framing shutter blade 605 with respect to the virtual pivot point 650. The location of the virtual pivot point 650 does not change as the angle value α changes. The angle value α is measured in degrees. Additionally, the rotation of the first arm 610 and the second arm 615 may cause the framing shutter blade 605 to slide up or down the track 645 of the support portion 640. Changing the relative position of the framing shutter blade 605 along the track 645 may change a thrust value ψ of the framing shutter blade 605. The thrust value ψ describes the location of the virtual pivot point 650 within a framing shutter gate 655. The thrust value ψ may change as the framing shutter blade 605 moves along the track 645 and describes the position of the virtual pivot point 650. In some embodiments, thrust is measured in millimeters of insertion into the framing shutter gate 655. When the thrust value ψ equals zero, the virtual pivot point 650 coincides with a point on the edge of the framing shutter gate 655. In some embodiments, the virtual pivot point 650 has a positive insertion wherein the virtual pivot point 650 is confined by the framing shutter gate 655 as represented in the current embodiment. In some embodiments, the virtual pivot point 650 has a negative insertion wherein the virtual pivot point 650 is outside of the framing shutter gate 655.

With respect to FIG. 6A, the first arm 610 and the second arm 615 both have a length L. One output shaft 635 is horizontally displaced from a first point A by a first distance λ₀, and a second distance λ₁ describes the horizontal displacement from the first point A and a second point B. A third distance λ₂ describes the horizontal displacement between the second point B and the third point C, and the other output shaft 635 is displaced horizontally from a point C by a fourth distance λ₃. The first arm 610 is at a first angle θ₁ relative to a horizontal axis μ that passes through the center of each output shaft 635, and the second arm 615 is at a second angle θ₂ relative to the horizontal axis μ. The point A is vertically displaced from the axis μ by a first height μ₁. The point C is vertically displaced from the axis u by a second height μ₂. A first height τ vertically separates the horizontal axis u and the point B. A thrust induced angle ρ describes the distance the virtual pivot point 650 moves when the framing shutter blade 605 is rotated. The following equations describe the forward kinematic relationships between the above-noted parameters of the framing shutter blade system 600. First, A, B, and C point locations are determined.

$$sin θ = \frac{μ}{L} ∴ μ = L sin θ \qquad EQN . 1$$

$$cos {θ}_{1} = \frac{{λ}_{0}}{L} ∴ {λ}_{0} = L cos {θ}_{1} \qquad EQN . 2$$

$${x}_{b} = {λ}_{1} + {λ}_{0} \qquad EQN . 3$$

$${x}_{b} = L cos {θ}_{1} + {λ}_{1} \qquad EQN . 4$$

$${λ}_{1} = {x}_{b} - L cos {θ}_{1} \qquad EQN . 5$$

$$cos {θ}_{2} = \frac{{λ}_{3}}{L} ∴ {λ}_{3} = L cos {θ}_{2} \qquad EQN . 6$$

$${x}_{b} = {λ}_{2} + {λ}_{3} = {λ}_{2} + L cos {θ}_{2} ∴ {λ}_{2} = {x}_{b} - L cos {θ}_{2} \qquad EQN . 7$$

Next, a slope m can be determined. The points A, B, and C are colinear. The coordinates for A (xₐ, yₐ), B(x_{b}, y_{b}), and C (x_{c}, y_{c}) can be written in terms of the symbols provided above.

xₐ=λ₀ EQN. 8

yₐ=μ₁ EQN. 9

x_{b}=λ₀+λ₁ EQN. 10

y_{b}=τ EQN. 11

x_{c}=λ₀+λ₁+λ₂ EQN. 12

y_{c}=μ₂ EQN. 13

The slope m created by points A, B, and C is:

$$\begin{matrix}m & = & \frac{{y}_{c} - {y}_{a}}{{x}_{c} - {x}_{a}} & EQN . 14 \\ & = & \frac{{μ}_{2} - {μ}_{1}}{( {λ}_{0} + {λ}_{1} + {λ}_{2} ) - ( {λ}_{0} )} & EQN . 15 \\ & = & \frac{{μ}_{2} - {μ}_{1}}{{λ}_{1} + {λ}_{2}} & EQN . 16\end{matrix}$$

The thrust of the B point (τ) and the angle (α) are given by:

$$τ = m {λ}_{1} + {μ}_{1} \qquad EQN . 17$$

$$τ = ( \frac{{μ}_{2} - {μ}_{1}}{{λ}_{1} + {λ}_{2}} ) {λ}_{1} + {μ}_{1} \qquad EQN . 18$$

$$α = arc tan m \qquad EQN . 19$$

Thrust (ψ) can then be determined:

$$cos α = \frac{ρ}{d} ∴ ρ = d cos α \qquad EQN . 20$$

$$ψ = τ + u + [ \frac{d}{cos α} - d ] \qquad EQN . 21$$

where ρ is the distance that the virtual pivot point 650 moves when the blade 605 is rotated, and is a function of the angle α and blade depth d. The extra −d is added to factor blade depth out of the offset since it is a constant.

The equations and the process of calculating the thrust value ψ and angle value α of the framing shutter blade 605 with respect to FIG. 6A are specifically used when the thrust value y of the framing shutter blade 605 is calculated before the angle value α of the framing shutter blade (e.g., thrust-then-angle). In this embodiment, thrust is determined first, and the physical restraints of the framing shutter blade system 600 because of the determined thrust value w limit the possible angle values a that can be achieved by the framing shutter blade system 600. However, it is also possible to calculate the angle value α before the thrust value ψ (e.g., angle-then-thrust). In this embodiment, angle value α is determined first, and the physical restraints of the framing shutter blade system 600 because of the determined angle value α limit the possible thrust value w that can be achieved by the framing shutter blade system 600.

In some embodiments, the thrust value ψ is determined before the angle value α (e.g., thrust-then-angle), as described above with respect to FIG. 6A. In such embodiments, the thrust value w defines a location of the virtual pivot point 650, and the angle value α defines a rotation of the framing shutter blade 605 about the virtual pivot point 650. As such, the location of the virtual pivot point 650 remains substantially fixed while the angle value α changes. However, in other embodiments, the angle value α may be determined before the thrust value ψ (e.g., angle-then-thrust). In these embodiments, the kinematic relationships of the framing shutter blade system 600 may be redefined such that the rotation of the framing shutter blade 605 is not about a fixed virtual pivot point, but instead is defined relative to a virtual pivot path.

FIG. 6B illustrates a framing shutter blade system 600 according to such an angle-then-thrust embodiment. The framing shutter blade system 600 includes similar components to those described above with respect to FIG. 6A, including the framing shutter blade 605, the first arm 610, the second arm 615, the plurality of framing shutter motors 630, and the support portion 640. Accordingly, like reference numerals indicate like components. In the embodiment of FIG. 6B, a virtual pivot circle 660 is defined, rather than a single virtual pivot point. The center of the virtual pivot circle 660 is located along the same longitudinal axis as point B. The framing shutter blade 605 is tangent to the virtual pivot circle 660. The virtual pivot circle 660 corresponds to a set of possible pivot locations that collectively define a path along which the framing shutter blade 605 effectively rotates. In this configuration, the angle value α defines a rotational orientation of the framing shutter blade 605 relative to the virtual pivot circle 660, and the thrust value ψ corresponds to a parameter that defines the size and/or position of the virtual pivot circle 660.

More specifically, the thrust value ψ may be used to determine a radius r of the virtual pivot circle 660 and/or a distance h associated with the virtual pivot circle 660. As illustrated in FIG. 6B, the virtual pivot circle 660 is bounded by an outer radius R and an inner radius r, where the radius r is a function of the thrust value ψ and the angle value a. In some embodiments, the radius r is determined based on a relationship between the thrust value ψ and the angle value α, such that the virtual pivot circle 660 varies in size as a function of the thrust value ψ. Distance h, outer radius R, and inner radius r are defined by the following equations with respect to the angle value α and the thrust value ψ:

$$h = R - ψ \qquad EQN . 22$$

$$cos ( α ) = \frac{r}{h} \qquad EQN . 23$$

$$r = h cos ( α ) ∴ r = ( R - ψ ) cos ( α ) \qquad EQN . 24$$

In operation, the angle value α is first defined, thereby establishing a desired rotational orientation of the framing shutter blade 605 relative to the virtual pivot circle 660. The thrust value ψ is then determined to define the appropriate radius r of the virtual pivot circle 660, thereby positioning the framing shutter blade 605 along the virtual pivot circle 660. As a result, the motion of the framing shutter blade 605 may be understood as a tangential motion along the virtual pivot circle 660, rather than a rotation about a fixed pivot point (e.g., virtual pivot point 650).

FIG. 6C illustrates a sectional view of a portion of the framing shutter gate 655 of FIG. 6B. The sectional view represents a geometric relationship between the framing shutter blade 605, the framing shutter gate 655, and the virtual pivot circle 660. In particular, the sectional view illustrates relationships between a radius r, a distance h, and the angle value α as the framing shutter blade 605 moves relative to the framing shutter gate 655 along a path defined by the virtual pivot circle 660. As shown, the angle value α corresponds to an angular relationship between the framing shutter blade 605 and a reference direction within the framing shutter gate 655, and the radius r corresponds to a function of the distance h and the angle value a. In some embodiments, the distance h is defined based on the thrust value, and the radius ris determined based on the distance h and the angle value a.

In contrast to the embodiment of FIG. 6A, in which the framing shutter blade 605 rotates about a fixed virtual pivot point 650, the embodiment of FIGS. 6B-6C enables the framing shutter blade 605 to move along a path defined by the virtual pivot circle 660. As a result, motion of the underlying components of the framing shutter blade system 600 (e.g., rotation of the first arm 610 and the second arm 615 and actuation of the plurality of framing shutter motors 630) produces a visual effect in which the framing shutter blade 605 appears to maintain a substantially constant orientation or position relative to an external reference, even while the underlying mechanism is moving.

This angle-then-thrust configuration may be advantageous in applications in which coordinated motion of the framing shutter blade system 600 and other components of the light fixture 100 (e.g., rotational motion of the light fixture or a portion thereof) is desired. For example, the virtual pivot circle 660 enables the framing shutter blade 605 to follow a trajectory that compensates for motion of the overall assembly, such that the framing shutter blade 605 appears substantially stationary while the assembly is rotating.

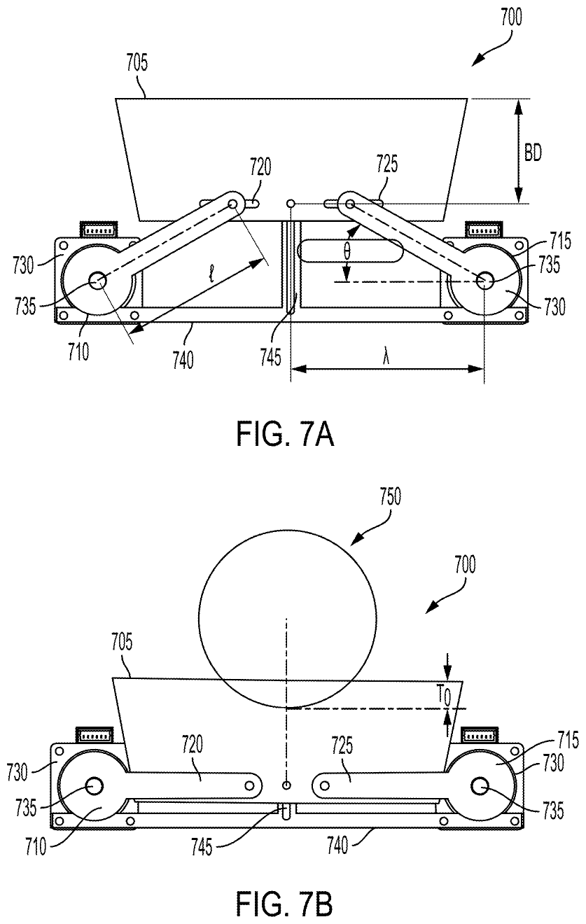

The above-noted equations that describe the forward kinematic relationships between the above-noted parameters are transcendental. The analytical solution is not tractable (i.e., a non-analytic solution is required). A solver (e.g., a non-analytical solver) can be used to solve for the first angle θ₁ and the second angle θ₂ of the first arm 610 and the second arm 615, respectively, given values for the angle α and the thrust ψ. The parameters used by the non-analytical solver to determine the first angle θ₁ and the second angle θ₂ are described with respect to FIGS. 7A and 7B.

FIG. 7A illustrates a framing shutter blade system 700 with a non-zero thrust. FIG. 7B illustrates a framing shutter blade system with a zero angle and a thrust at zero millimeters. With respect to FIGS. 7A and 7B, the framing shutter blade system 700 includes a framing shutter blade 705, a first arm 710, a second arm 715, a first blade slot 720, a second blade slot 725, a plurality of framing shutter motors 730, and a support portion 740. The framing shutter blade 705 includes the first blade slot 720 and second blade slot 725. The first blade slot 720 and second blade slot 725 are configured to receive the first arm 710 and the second arm 715 in a sliding manner. The first arm 710 and second arm 715 each connect to one of the plurality of framing shutter motors 730 through an output shaft 735 of each of the plurality of framing shutter motors 730. Each of the plurality of framing shutter motors 730 is at least partially fixed to the support portion 740. The support portion 740 further includes a track 745 configured to receive the framing shutter blade 705 in a sliding manner.

The first arm 710 and the second arm 715 in FIG. 7A have a non-zero arm angle θ. The plurality of framing shutter motors 730 rotates the first arm 710 and the second arm 715 by rotating the output shaft 735 of each of the plurality of framing shutter motors 730 to achieve the arm angle θ. The rotation of the first arm 710 and the second arm 715 by the arm angle θ causes the relative positions of the first arm 710 and the second arm 715 within the first blade slot 720 and the second blade slot 725, respectively, to change. As a result, a non-zero thrust of the framing shutter blade 705 is established. Additionally, the rotation of the first arm 710 and the second arm 715 causes the framing shutter blade 705 to slide up the track 745 of the support portion 740. A midpoint distance 2 refers to the horizontal distance between a vertical axis that passes through the output shaft 735 and a vertical axis that passes through the track 745 of the support portion 740. Framing shutter blade 705 also has a blade depth BD. The blade depth BD refers to the vertical distance between the top of the framing shutter blade 705 and a horizontal axis that passes through the first blade slot 720 and the second blade slot 725.

The first arm 710 and the second arm 715 in FIG. 7B have an arm angle of zero degrees. Additionally, a thrust at zero degrees T₀ refers to a thrust of the framing shutter blade into a framing shutter gate 750 when the first arm 710 and the second arm 715 both have an arm angle of zero degrees. The arm angle θ has a minimum arm angle and a maximum arm angle that describe the limits for the range of motion of the first arm 710 and the second arm 715. In some embodiments, the blade depth BD, the midpoint distance λ, the thrust at zero degrees T₀, the minimum arm angle, and the maximum arm angle are the initial parameters used by the non-analytical solver to solve for the arm angle θ.

An example of a non-analytical solver that can be used to solve for the first angle θ₁ and the second angle θ₂ is a gradient descent algorithm. The gradient descent algorithm finds a solution by iteratively moving a guessed solution in all directions on a cost plane, and then moves in the direction that reduces a cost the most. The cost is calculated by, for example, subtracting a current shutter blade position (calculated with the above forward kinematics for the thrust-then-angle embodiment) from a target position, as set forth below.

e_{ψ}=ψ_{target}−ψ(θ₁,θ₂) EQN.25

$${e}_{α} = ( {α}_{target} - α ( {θ}_{1} , {θ}_{2} ) ) ω \qquad EQN . 26$$

$$C = \sqrt{( {e}_{ψ}^{2} + {e}_{α}^{2} )} \qquad EQN . 27$$

In the above equations, cost is represented by C, the distance between the target thrust value and the thrust value is represented by e_{ψ}, and the distance between the target angle value and the angle value is represented by e_{α}. Additionally, ω represents an angle-thrust weight. When the angle-thrust weight is less than 1, the thrust value is proportionally given a larger priority. When the angle-thrust weight is greater than 1, the angle is proportionally given a larger priority. When the angle-thrust weight is equal to 1, the thrust value and the angle value are given the same priority.

In the embodiment in which the thrust value ψ is determined prior to the angle value α, the cost function may be defined based on a difference between a target thrust value and a calculated thrust value and a difference between a target angle value and a calculated angle value, as described above. In the embodiment in which the angle value α is determined prior to the thrust value ψ, the cost function may instead be defined based on a parameter associated with the virtual pivot circle (e.g., a radius r of the virtual pivot circle) and the angle value α. In such embodiments, the thrust value ψ may be indirectly represented through the parameter associated with the virtual pivot circle, such as the radius r. In this embodiment, the cost is calculated by, for example, subtracting a current shutter blade position (calculated with the above forward kinematics for the angle-then-thrust embodiment) from a target position, as set forth below.

$${e}_{r} = {r}_{target} - r ( {θ}_{1} , {θ}_{2} ) \qquad EQN . 28$$

$${e}_{α} = ( {α}_{target} - α ( {θ}_{1} , {θ}_{2} ) ) ω \qquad EQN . 29$$

$$C = \sqrt{( {e}_{r}^{2} + {e}_{α}^{2} )} \qquad EQN . 30$$

The cost function provided above is only an example of a cost function that could be used. However, the example cost function is the Euclidean norm, which increases with the distance between the target point and the current point. As a result, the cost function guarantees that the solution for an out of gamut thrust-angle request will be as close as possible to the target. Regardless of whether the thrust value ψ is determined before the angle value α or the angle value α is determined before the thrust value ψ, the non-analytical solver may be used to determine actuator positions (e.g., θ₁ and θ₂) that achieve a desired orientation of the framing shutter blade.

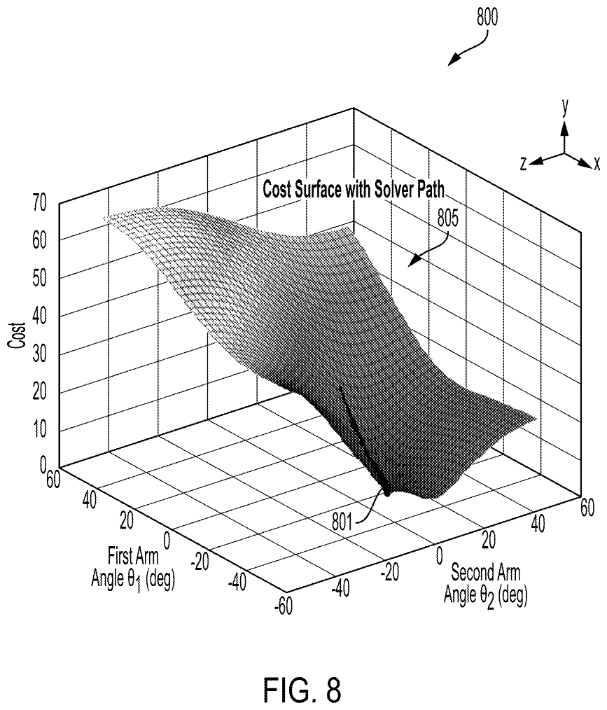

FIG. 8 illustrates a graph 800 of a cost surface 805 for the above cost function for the thrust-then-angle embodiment. The graph 800 includes a y-axis, z-axis, and x-axis. The y-axis shows the value of the cost function, while the z-axis (left) and x-axis (right) show θ₁ and θ₂, respectively. The cost surface 805 includes a solver path 810. As previously described, a non-analytical solver can be used to solve the inverse kinematics and determine the first angle θ₁ and the second angle θ₂ of a first arm (e.g., first arm 610) and a second arm (e.g., second arm 615), respectively, for a given thrust and angle. The non-analytical solver uses an initial set of parameters in order to solve for the first angle θ₁ and the second angle θ₂. In some embodiments, a blade depth, a midpoint distance, a thrust at zero degrees, a minimum arm angle, and a maximum arm angle are the initial set of parameters. The non-analytical solver also uses an angle value (e.g., angle value a) and a thrust value (e.g., thrust value v) as inputs.

In the current example, the initial guessed solution of the gradient descent algorithm is θ₁=θ₂=0 such that thrust is 20 millimeters and the angle is 25 degrees. The non-analytical solver then calculates the slope from the guessed solution to all values of θ₁ and θ₂ in every direction. The non-analytical solver determines the greatest negative slope and moves the guessed solution to the next values of θ₁ and θ₂. This process is iterated until the lowest cost value of the cost function surface is reached. The solver path 810 indicates the path taken by the non-analytical solver starting from the initial guess and ending at the lowest cost value of the cost function surface. In some embodiments, the lowest cost value on the cost function surface corresponds to a closest in-gamut output value for both θ₁ and θ₂ for an out-of-gamut input value for the thrust value and the angle value.

In some embodiments, the non-analytical solver implements an algorithm or method other than gradient descent. For example, a table stored in the memory (e.g., memory 360) includes precalculated angle and thrust value combinations that are physically achievable by the framing shutter blade. The electronic processor, in response to receiving a desired angle and thrust, performs a look-up operation and controls the framing shutter motors according to the values stored in the table. When a desired angle and thrust combination is not present in the table (e.g., out of gamut), the electronic processor determines the table values that differ the least from the desired orientation, and controls the framing shutter motors according to this determined adjusted orientation. In some embodiments, the table includes experimentally determined values of in gamut and out of gamut angle and thrust values that are compared to a received desired orientation to determine whether the desired orientation is in gamut or out of gamut. When a desired orientation is out of gamut, the electronic processor determines the closest orientation, determines whether the orientation is in gamut, and controls the framing shutter motors based on this adjusted orientation. When the adjusted orientation is out of gamut, the electronic processor calculates the next closest orientation until an in gamut orientation is determined. In some embodiments, an angle-thrust weight is used to determine which of the angle or thrust is prioritized (e.g., differs the least from the corresponding desired value) in determining the adjusted orientation based on the information stored in the table.

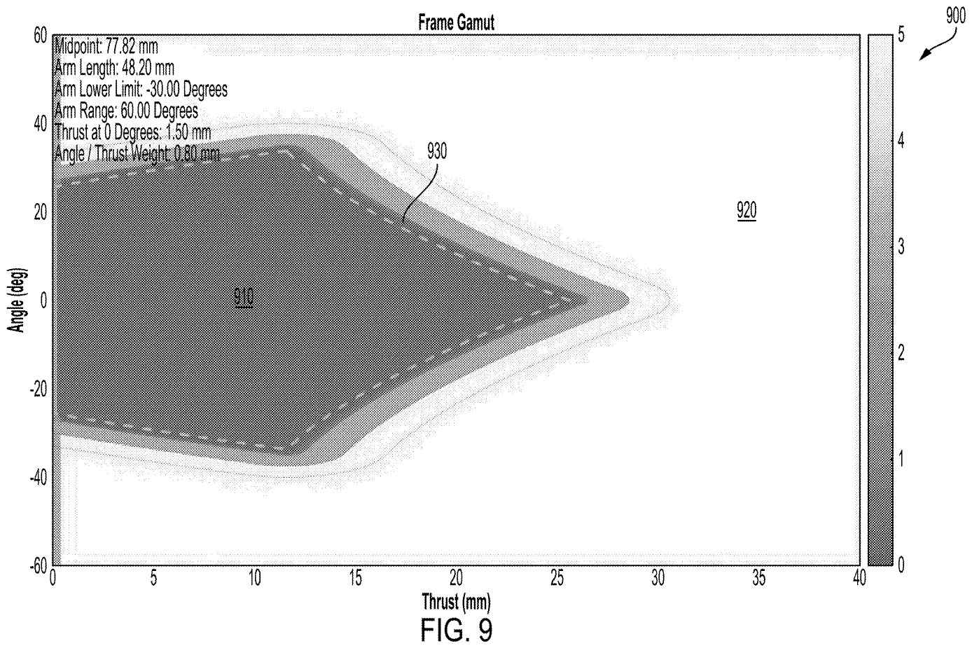

FIG. 9 illustrates a gamut chart 900 of a framing shutter blade (e.g., framing shutter blade 605). The gamut chart 900 provides a range of motion of a framing shutter blade that can be achieved for a given angle and thrust. The gamut chart 900 includes an in-gamut region 910, an out-of-gamut region 920, and a boundary 930. In-gamut region 910 represents orientations which a framing shutter blade can physically achieve given the range of motion of the framing shutter blade. The out-of-gamut region 920 represents orientations which a framing shutter blade cannot physically achieve given the range of motion of the framing shutter blade. The boundary 930 represents the border of orientations achievable by a framing shutter blade. The cost function described above is designed to identify an achievable orientation (in-gamut region 910) for an out-of-gamut request (e.g., out-of-gamut region 920) that is as close as possible to the out-of-gamut request.

In some embodiments, the gamut may be defined in terms of alternative parameters associated with the orientation of the framing shutter blade 605. For example, in the angle-then-thrust embodiment, the gamut may be defined with respect to the angle value α and a parameter associated with a virtual pivot circle (e.g., a radius r), rather than directly with respect to the thrust value v.

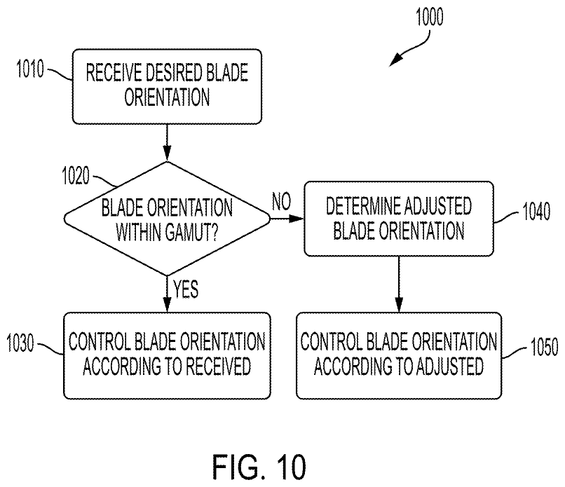

FIG. 10 illustrates a method 1000 for controlling the light fixture 100. The method 1000 is initiated when the controller 300 receives a desired orientation of a framing shutter blade (e.g., framing shutter blade 605) (STEP 1010). After receiving the desired orientation (e.g., thrust and angle) of the framing shutter blade, the controller 300 determines whether the desired orientation is in a gamut (e.g., in-gamut region 910) of the framing shutter blade (STEP 1020). When the desired orientation of the framing shutter blade is deemed to be in the gamut of the framing shutter blade, the controller controls the orientation of the framing shutter blade according to the received desired orientation of the framing shutter blade (STEP 1030). When the desired orientation of the framing shutter blade is deemed to be outside the gamut of the framing shutter blade, the controller determines an adjusted orientation of the framing shutter blade (STEP 1040). As described above, a solver (e.g., the non-analytical solver) can be used to adjust the orientation of the framing shutter blade to be within the gamut of the framing shutter blade. The controller 300 then controls the orientation of the framing shutter blade according to the adjusted orientation of the framing shutter blade (STEP 1050).

In some embodiments, STEP 1040 also includes receiving a desired angle-thrust weight (see EQN. 26 above). When the angle-thrust weight is greater than 1, the angle is proportionally given a larger priority. When the angle-thrust weight is less than 1, the thrust is proportionally given a larger priority. When the angle-thrust weight is equal to 1, the thrust value and the angle value are given the same priority.

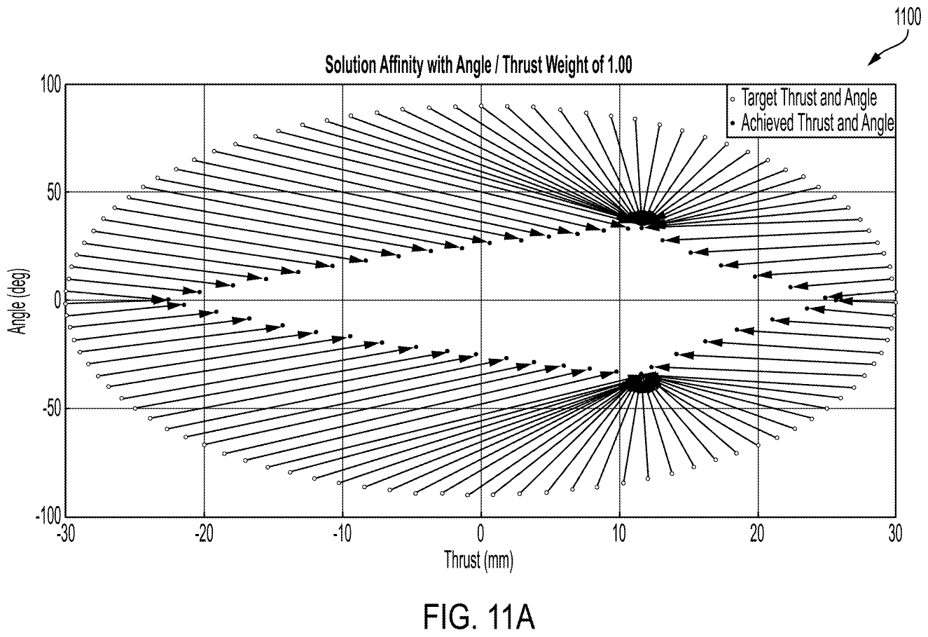

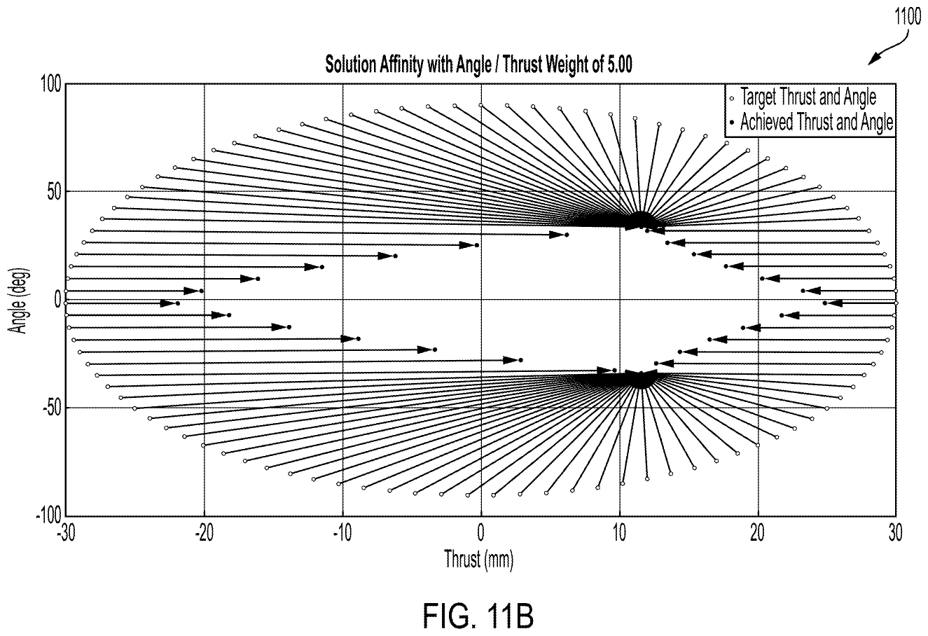

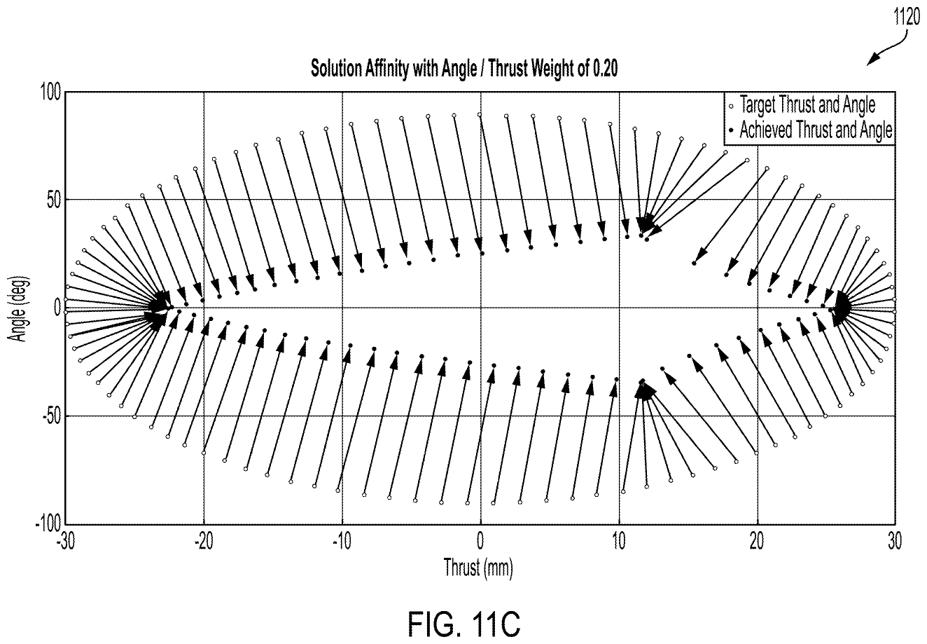

For example, FIG. 11A illustrates a graph 1100 of target thrusts and target angles and achievable thrusts and achievable angles according to a weight that equally prioritizes achieving the angle value and the thrust value. In this example, the angle-thrust weight (e.g., angle-thrust weight ω) is set to equal 1.00. In some embodiments, the angle-thrust weight is user selectable through a user interface (e.g., user input module 325). In some embodiments, the angle-thrust weight is automatically selectable (e.g., stored in memory 360). In some embodiments, the angle-thrust weight changes in real time as the light fixture operates as opposed to the angle-thrust weight being a predetermined and unchanging value preloaded and stored in the memory. Assigning equal priority to the angle value and the thrust value results in the cost function determining angle values that are at least slightly different from the target angle values and thrust values that are at least slightly different from the target thrust values with no emphasis on one over the other.

FIGS. 11B and 11C illustrate the effects of prioritizing either achieving the angle value or achieving the thrust value. FIG. 11B illustrates a graph 1110 of target thrusts and target angles and achievable thrusts and achievable angles according to a weight that prioritizes the angle value. In this example, the angle-thrust weight (e.g., angle-thrust weight ω) is set to equal 5.00. At this angle-thrust weight, the angle value is prioritized over the thrust value. Prioritizing the angle value over the thrust value causes a greater number of the achievable angle values to be equal to the target angle values in comparison to the target angle values and achievable angle values when the angle value and thrust value are prioritized equally. Note that the lines pointing from target positions to actual positions have become more horizontal, which is a result of the solver being more willing to travel away from a target thrust to achieve the target angle.

FIG. 11C illustrates a graph 1120 of target thrusts and target angles and achievable thrusts and achievable angles according to a weight that prioritizes the thrust value. In this example, the angle-thrust weight (e.g., angle-thrust weight ω) is set to equal 0.20. At this angle-thrust weight, the thrust value is prioritized over the angle value. Prioritizing the thrust value over the angle value causes a greater number of the achievable thrust values to be equal to the target thrust values in comparison to the target thrust values and achievable thrust values when the angle value and thrust value are prioritized equally. Note that the lines pointing from target positions to actual positions have become more vertical, which is a result of the solver being more willing to travel away from a target angle to achieve the target thrust.

Although described with respect to thrust value v and angle value a, in some embodiments the thrust value w illustrated in FIGS. 11A-11C may correspond to or be replaced by a parameter associated with a virtual pivot circle (e.g., a radius r), particularly in angle-then-thrust embodiments.

Thus, embodiments described herein provide, among other things, light fixtures and methods for controlling the same. Various features and advantages are set forth in the following claims.

What is claimed is:

1. A light fixture comprising:
a housing;
a light source;
a framing shutter system including:
a framing shutter gate,
a framing shutter blade, and
a plurality of framing shutter motors connected to the framing shutter blade; and
an electronic processor electrically connected to the light source and the framing shutter system, the electronic processor configured to:
determine a desired orientation of the framing shutter blade defined by a desired first value and a desired second value,
determine whether the desired orientation is within a set of physically possible positions of the framing shutter blade,
determine, in response to the desired orientation being outside of the set of physically possible positions of the framing shutter blade, an adjusted orientation of the framing shutter blade defined by an adjusted first value and an adjusted second value, wherein the adjusted second value is determined based on the adjusted first value, and wherein at least one of the adjusted first value and the adjusted second value is determined based on the desired first value and the desired second value, the adjusted orientation of the framing shutter blade corresponding to an orientation for the framing shutter blade that is included in the set of physically possible positions, and
control the plurality of framing shutter motors to move the framing shutter blade to the adjusted orientation.

2. The light fixture of claim 1, wherein the adjusted first value and the adjusted second value are determined based on a weight that prioritizes one of the desired first value and the desired second value relative to the other of the desired first value and the desired second value.

3. The light fixture of claim 1, wherein the desired first value is an angle value of the framing shutter blade and the desired second value is a thrust value of the framing shutter blade.

4. The light fixture of claim 3, wherein the angle value defines a rotational orientation of the framing shutter blade relative to a virtual pivot circle.

5. The light fixture of claim 4, wherein the thrust value is used to determine a parameter that defines a size or position of the virtual pivot circle.

6. The light fixture of claim 5, wherein the parameter is a radius of the virtual pivot circle.

7. The light fixture of claim 4, wherein the framing shutter blade is tangent to the virtual pivot circle.

8. The light fixture of claim 4, wherein the virtual pivot circle defines a path along which the framing shutter blade moves.

9. The light fixture of claim 1, wherein the desired first value is a thrust value of the framing shutter blade and the desired second value is an angle value of the framing shutter blade.

10. The light fixture of claim 9, wherein the thrust value defines a location of a virtual pivot point and the angle value defines a rotation of the framing shutter blade about the virtual pivot point.

11. A method for controlling a light fixture, the method comprising:
determining, using an electronic processor, a desired orientation of a framing shutter blade defined by a desired first value and a desired second value;
determining, using the electronic processor, whether the desired orientation is within a set of physically possible positions of the framing shutter blade;
determining, using the electronic processor and in response to the desired orientation being outside of the set of physically possible positions of the framing shutter blade, an adjusted orientation of the framing shutter blade defined by an adjusted first value and an adjusted second value, wherein the adjusted second value is determined based on the adjusted first value, and wherein at least one of the adjusted first value and the adjusted second value is determined based on the desired first value and the desired second value, the adjusted orientation of the framing shutter blade corresponding to an orientation for the framing shutter blade that is included in the set of physically possible positions; and
controlling, using the electronic processor, a plurality of framing shutter motors to move the framing shutter blade to the adjusted orientation.

12. The method of claim 11, wherein determining the adjusted orientation further includes determining the adjusted first value and the adjusted second value based on a weight that defines a relative priority between the desired first value and the desired second value.

13. The method of claim 11, wherein determining the desired orientation further includes determining an angle value and a thrust value of the framing shutter blade, wherein the desired first value is the angle value and the desired second value is the thrust value.

14. The method of claim 13, wherein determining the angle value further includes determining a rotational orientation of the framing shutter blade relative to a virtual pivot circle.

15. The method of claim 14, wherein determining the thrust value further includes determining a parameter that defines a size or position of the virtual pivot circle.

16. The method of claim 15, further comprising:
determining a radius of the virtual pivot circle based on the thrust value.

17. The method of claim 14, wherein the framing shutter blade is tangent to the virtual pivot circle.

18. The method of claim 11, wherein determining the desired orientation further includes determining a thrust value and an angle value of the framing shutter blade, wherein the desired first value is the thrust value and the desired second value is the angle value.

19. The method of claim 18, wherein determining the thrust value further includes determining a location of a virtual pivot point and determining the angle value further includes determining a rotation of the framing shutter blade about the virtual pivot point.

20. A light fixture comprising:
a housing;
a light source;
a framing shutter blade system including:
a first arm,
a second arm,
a framing shutter blade including a first blade slot configured to receive the first arm in a slidable manner and a second blade slot configured to receive the second arm in a slidable manner,
a first framing shutter motor including a first output shaft, the first framing shutter motor being connected to the first arm via the first output shaft, and
a second framing shutter motor including a second output shaft, the second framing shutter motor being connected to the second arm via the second output shaft; and
an electronic processor electrically connected to the light source and the framing shutter blade system, the electronic processor configured to:
receive a desired angle of the framing shutter blade,
receive a desired thrust of the framing shutter blade,
determine a desired orientation based on the desired angle and the desired thrust,
determine an adjusted orientation of the framing shutter blade defined by an adjusted angle and an adjusted thrust, wherein at least one of the adjusted angle and the adjusted thrust is determined based on the desired angle and the desired thrust,
determine that the adjusted orientation is within a set of physically possible positions of the framing shutter blade, and
adjust the first arm and the second arm, in response to determining the adjusted orientation is within the set of physically possible positions, by controlling the first framing shutter motor and the second framing shutter motor to move the framing shutter blade to the adjusted orientation,
wherein the desired angle defines a rotational orientation of the framing shutter blade relative to a virtual pivot circle, and
wherein the desired thrust corresponds to a parameter that defines a size or position of the virtual pivot circle.
